(19) United States
(12) Patent Application Publication
(10) Pub. No.: US 2002/0163448 A1
(43) Pub. Date: Nov. 7, 2002

(54) Apparatus and method of indicating stall using proximity sensing

(76) Inventor: Thomas J. Bachinski, Lakeville, MN (US)

Correspondence Address: CALFEE HALTER & GRISWOLD, LLP, 800 SUPERIOR AVENUE, SUITE 1400, CLEVELAND, OH, 44114, US

(21) Appl. No.: 09/848,730

(22) Filed: May 3, 2001

(51) Int. Cl. G08B 21/00

(52) U.S. Cl. 340/966; 340/945; 340/606; 340/610

(57) ABSTRACT

A stall indicator for use on an aircraft comprises: a structure for mounting a housing at a leading edge of a wing of the aircraft; a paddle disposed to air flow at the leading edge of the wing and movable in response to the air flow; and a proximity sensor disposed at the housing for detecting movement of the paddle at a sensing area. Also disclosed is a method of indicating when an aircraft is approaching a stall condition comprising the steps of: permitting a paddle, disposed at a leading edge of a wing of the aircraft, movement with respect to a sensing area in response to air flow at the wing; detecting movement of the paddle by proximity sensing with electrical energy in the vicinity of the sensing area; and effecting an electrical signal representative of the detected movement of the paddle, which signal being indicative of an approaching stall condition at the wing.

### BACKGROUND OF THE INVENTION

The present invention is directed to stall indication devices, in general, and more particularly, to apparatus and method of indicating an approaching stall condition of an aircraft using proximity sensing.

Stall indicators are disposed on aircraft to detect and provide an indication to the pilot when the aircraft is approaching a stall condition. Generally, these indicators are mounted on the leading edge of a wing of the aircraft and include a paddle which protrudes a short distance from the wing. The paddle is hinged at a pivot point on a housing of the indicator and moves in response to air flow conditions across the wing. Currently, mechanical micro switches are used for the switching mechanism. At rest, the paddle will be forced to a position against the housing by gravity. A mechanical coupling between the paddle and micro switch will force the metal contacts of the switch open under this condition.

In operation, under normal conditions when air is crossing the wing at laminar flow and the stagnation point is above the paddle, the paddle of the stall indicator will remain against the housing. However, as the angle of attack of the wing of the aircraft is increased, turbulence and delaminated air flow is created at the wing edge and across the wing causing the wing to lose its aerodynamic properties or lift, i.e. approaching stall. Under these conditions, the stagnation point moves below the paddle causing air to pass under the paddle and force it to a position away from the housing. In this paddle position, the mechanical coupling will cause the metal contacts of the switch to close providing an indication to the pilot that the wing is in a near stall condition. Depending on the air foil, the micro switch may be positioned on the leading edge such that contact closure will occur at an angle of attack slightly below the angle at which the wing stalls due to lack of lift, thus allowing the pilot time to react to the approaching stall condition.

There are a number of drawbacks with the current micro switch type stall indication devices. First, the metal contacts have a tendency to arc when opened causing damage to the contacts themselves and possibly surrounding mechanical linkages and electrical components as well. In addition, the mechanical movement of the linkages cause wear over time. Accordingly, these type switches have relatively short life cycles and require frequent repair and maintenance due to their mechanical shortcomings. This is very costly to the aircraft industry.

The present invention provides for a stall indicator which complies with the requirements of the current stall indicators in form, fit and function, but overcomes the drawbacks as a result of their mechanical shortcomings.

### SUMMARY OF THE INVENTION

In accordance with one aspect of the present invention, a stall indicator for use on an aircraft comprises: a housing; a structure for mounting the housing at a leading edge of a wing of the aircraft; a paddle disposed to air flow at the leading edge of the wing and movable in response to the air flow; and a proximity sensor disposed at the housing for detecting movement of the paddle at a sensing area.

In accordance with another aspect of the present invention, a method of indicating when an aircraft is approaching a stall condition comprises the steps of: permitting a paddle disposed at a leading edge of a wing of the aircraft movement with respect to a sensing area in response to air flow at the wing; detecting movement of the paddle by proximity sensing with electrical energy in the vicinity of the sensing area; and effecting an electrical signal representative of the detected movement of the paddle, which signal being indicative of an approaching stall condition at the wing.

### BRIEF DESCRIPTION OF THE DRAWINGS

FIG. 1 is a cross-sectional sketch of a stall indicator using proximity sensing suitable for embodying the principles of the present invention.

FIG. 2 is an isometric sketch of the stall indicator of FIG. 1.

FIG. 3 is a block diagram schematic of a proximity sensor suitable for use in the embodiment of FIGS. 1 and 2.

### DETAILED DESCRIPTION OF THE INVENTION

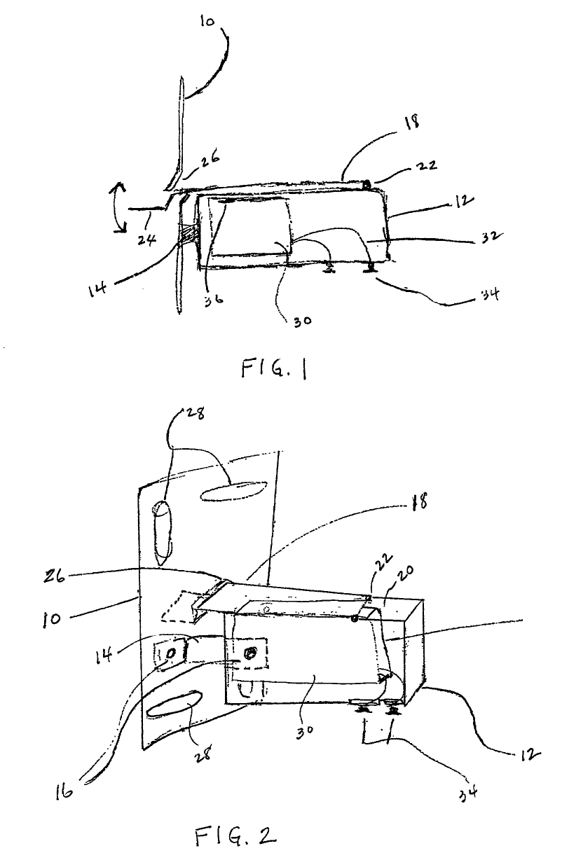

When used in the context of describing the present invention, proximity sensing or a proximity sensor using proximity sensing shall mean non-contact sensing through use of electrical energy and solid-state circuitry. An exemplary embodiment of a stall indicator suitable for use in describing aspects of the present invention is shown in the illustrations of FIGS. 1 and 2. Referring to FIGS. 1 and 2, a structure for mounting the stall indicator to a leading edge of a wing of an aircraft comprises a mounting plate 10. The plate 10 is pliable for being configured to the curved shape of the leading edge. A housing 12 of the stall indicator is mounted to the plate 10 using an attachment bracket 14 and rivets 16, for example. One end of a paddle 18 is pivotably hinged to a surface 20 of the housing 12 at point 22. The other end 24 of the paddle 18 is disposed through a slot 26 in the plate 10 to extend beyond the wing a predetermined distance to render it in the air flow at the leading edge and movable in response to the air flow. The mounting plate 10 includes screw holes 28 for mounting the plate 10 to the leading edge of the wing with screws, for example. The holes 28 are enlarged to permit adjustment of the plate 10 at the wing edge before being secured in place.

At rest, the paddle 18 rests against the surface 20 of the housing 12 and under normal or laminar air flow conditions where the stagnation point is above the paddle 18, the paddle 18 remains in this position. But, when the wing undergoes a change in angle of attack in a direction to cause loss of lift, turbulent or delaminated air flow occurs and the stagnation point moves below the paddle 18 which permits air to pass under the paddle 18 and force it away from the surface 20 to a new position which is indicative of the wing approaching a stall condition. In the present embodiment, a proximity sensor is used to detect this movement or change in position of the paddle 18 and effect a stall indication signal representative of this condition. In this embodiment, the plate 10 may be adjusted to position the paddle 18 at the leading edge to provide the stall indication signal, as will become more evident from the description below, at an angle of attack slightly below the angle at which the wing stalls due to lack of lift.

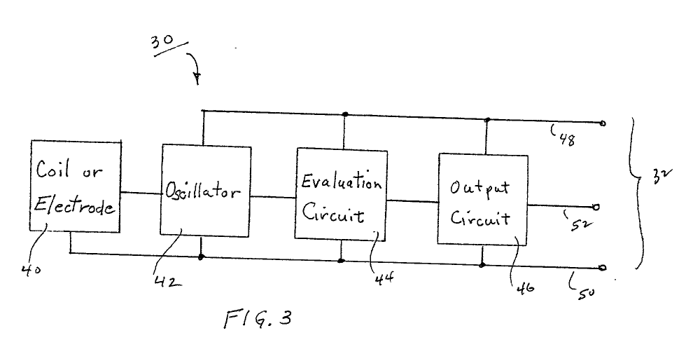

Accordingly, a proximity sensor 30 is disposed at the housing 12. Wires 32 are used to interface power and signals to and from the proximity sensor 30 through screw connectors 34, for example. The proximity sensor 30 generates a form of electrical energy at a sensing area 36 which may be in the vicinity of the surface 20 of the housing 12. A block diagram schematic of a proximity sensor 30 suitable for use in the embodiment of FIGS. 1 and 2 is shown in FIG. 3. In one embodiment, the block diagram schematic of FIG. 3 represents an inductive proximity sensor wherein block 40 comprises a coil of wire wrapped in a ferrite core, for example. An oscillator circuit 42 drives the wire coil of 40 to generate electrical energy in the form of an electromagnetic field shaped at the sensing area 36 and directed towards the target or paddle 18.

In this embodiment, the paddle 18 comprises electrically conductive material, like aluminum, for example. So when it enters the magnetic field generated by the proximity sensor 30, energy is drawn from the field and induced into the paddle 18. As the paddle 18 becomes closer to the sensing area 36 or surface 20, like the position it is in at rest or under normal air flow conditions, the energy losses become so large that the oscillator circuit 42 can not maintain oscillation and the field collapses. This breakdown in oscillation is detected by an evaluation circuit 44 which governs the state of an output circuit 46 which may include a solid-state switch, for example. In contrast, as the paddle moves away from the sensing area 36 or surface 20 to a new position, a point is reached where little or no energy is drawn from the magnetic field such that oscillation is maintained by the oscillator circuit 42. The evaluation circuit 44 detects the state of oscillation and governs the output circuit to change state or output a different signal. Moreover, circuits 42, 44 and 46 may comprise solid-state circuitry that is powered from the wires 32. For example, a wire 48 may carry power to the circuits 42, 44 and 46 at a predetermined voltage potential with wire 50 being the return or ground potential.

In addition, the solid-state switch of the output circuit 46 may be driven into conduction and non-conduction to represent the positions of the paddle 18. For example, when the paddle 18 is close to or rests against the surface 20, the solid-state switch may be non-conducting providing an open circuit between the wires 52 and 50 which are coupled to the switch. On the other hand, when the paddle 18 is forced away from the service area 36 or surface 20 which is an indication of an approaching stall condition, the solid-state switch of the output circuit 46 may be driven into conduction providing for a closed circuit between wires 52 and 50. It is understood that in some applications, a non-conduction state may represent an approaching stall condition without deviating from the present invention. In any event, the wires 52 and 50 may be connected via screw connectors 34 to aircraft wiring which may route the signals to the cockpit or another convenient place on the aircraft to drive an indicator which provides an indication to the pilot of an approaching stall condition.

In another embodiment, block 40 represents an electrode assembly including an active electrode and an earth electrode wherein the assembly 40 generates electrical energy in the form of an electrostatic field between the active and earth electrodes substantially at the sensing area 36. As the paddle 18 which may be comprised of an electrically conductive material enters the electrostatic field a capacitance of the assembly 42 increases. When the capacitance becomes large enough, an oscillation is set up in the oscillator circuit 42 which is detected by the evaluation circuit 44. In response, the evaluation circuit 44 drives the output circuit to a predetermined state or to produce a predetermined signal. In contrast, when the paddle 18 is forced away from the sensing area 36 or surface 20, the capacitance of the assembly 40 decreases to the point where oscillation of circuit 42 can not be maintained. This lack of oscillation is detected by the evaluation circuit 44 which, in turn, causes the output circuit to change state or effect a new signal. In this embodiment, the solid-state switch of the output circuit 46 is driven into conduction providing for a closed circuit between wires 52 and 50 as an indication of an approaching stall condition. But, it is understood that the output circuit 46 may be modified to effect a non-conduction state providing for an open circuit between wires 52 and 50 as an indication of stall for another application without deviating from the principles of the present invention.

Examples of suitable inductive and capacitive proximity sensors may be of the type manufactured by IMF Efector, Inc. The model of design choice for an inductive proximity sensor will be based on certain design parameters like the conductivity and permeability of the paddle 18, the distance and position of the paddle 18 from the service area 36, and the dimension of the paddle 18, for example. Likewise, the model of design choice for a capacitive proximity sensor will depend on parameters like the distance and position of the paddle 18 from the service area 36 and the dimensions of the paddle 18, for example. In some cases, the electrode assembly 40 may include both a reference capacitor and an active sensing capacitor to avoid the complications arising from environmental and noise effects.

In yet another embodiment, the proximity sensor 30 may comprise an optical arrangement utilizing light in the visible or invisible spectrum. For example, a light emitting diode (LED) may transmit light at the service area 36 to a reflector on the paddle 18 which reflects light to a photodiode at a predetermined orientation. That is, if the paddle 18 is close to or against the surface area 20, light will be reflected to and detected by the photodiode. As the paddle 18 is forced away from the surface 20, it will take upon a different orientation which causes light to be reflected away from the photodiode. The oscillator circuit 42 may cause the light to be pulsed at a predetermined frequency and the output signal of the photodiode may be band pass filtered to accept an oscillating signal only in this frequency range. Accordingly, the evaluation circuit 44 detects the presence or absence of signal from the photodiode and drives the output circuit 46 to a corresponding state.

In addition, for some applications, the proximity sensor 30 may be disposed inside the housing 12 as shown by the illustrations of FIGS. 1 and 2. The housing 12 may be comprised of a plastic material and hermetically sealed to keep out particles and other pollutants in the environment from causing erroneous readings of the sensor 30 or even damage thereto. Moreover, the dimensions of the housing 12 may be the same or similar to current micro switch indicators dimensions so that the present embodiment of the invention may be a direct replacement of these current indicators in form, fit and function.

While the aforementioned embodiments have been described for paddle movement in just two positions, it is understood that the invention is not so limited. Rather, the electrical energy may be varied by the paddle 18 in proportion its movement away from the sensing area 36 resulting in a variation to the oscillating signal of oscillator 42, for example. The evaluation circuit 44 may detect this variation and cause the output circuit 46 to produce an amplitude varying signal, for example, across signal lines 52 and 50 in proportion to the movement of the paddle 18 from its rest position. In this manner, a variable stall indication signal may be provided to the pilot or operator which may be indicative of the changing angle of attack of the wing, for example.

In another aspect of the present invention, a method of indicating when an aircraft is approaching a stall condition comprises the steps of: permitting the paddle 18, disposed at a leading edge of a wing of the aircraft, movement with respect to the sensing area 36 in response to air flow at said wing; detecting movement of the paddle 18 by proximity sensing with electrical energy in the vicinity of the sensing area 36; and effecting an electrical signal between wires 52 and 50, for example, when detected movement of the paddle 18 is indicative of an approaching stall condition at said wing. The electrical energy for proximity sensing may be generated as an electromagnetic field or an electrostatic field in the vicinity of the sensing area 36 for detecting the movement of the paddle 18. In one embodiment, the step of generating includes the steps of: affecting a change in the electrical energy by the movement of the paddle 18; and detecting a position of the paddle based on the affected change in electrical energy. The change in electrical energy may be affected by an electrically conductive paddle. In addition, the electrical signal may be effected through one of a conduction state and non-conduction state of the solid-state switch in the output circuit 46.

Accordingly, the stall indicator using proximity sensing of the present embodiments provides a number of benefits over the mechanical micro switches of the current indicators. For example, the solid-state circuitry thereof has no moving parts which can wear over time, can be made small in size which is affords variable packaging designs, is highly reliable, and the accuracy and range of the switch may be made adjustable.

While the present invention has been described herein above in connection with a number of embodiments, it is understood that this was done merely by way of example and none of these embodiments should be used to limit the present invention in any way, shape or form. Rather the present invention should be construed in broad scope and breadth in accordance with the recitation of the claims appended hereto.

What is claimed is:

1. A stall indicator for use on an aircraft comprising:
a housing;
a structure for mounting said housing at a leading edge of a wing of said aircraft;
a paddle disposed to air flow at said leading edge of said wing and movable in response to said air flow; and
a proximity sensor disposed at said housing for detecting movement of said paddle at a sensing area.

2. The stall indicator of claim 1 wherein the paddle is in a first position with respective to the sensing area under normal air flow conditions and movable to a second position with respect to the sensing area as the air flow approaches a stall condition.

3. The stall indicator of claim 2 wherein the proximity sensor detects the first and second positions of the paddle by electrical energy at the sensing area to generate first and second signals when the paddle is in the first and second positions, respectively.

4. The stall indicator of claim 3 wherein the proximity sensor comprises an inductive circuit for generating an electromagnetic field in the vicinity of the sensing area for detecting the first and second positions of the paddle.

5. The stall indicator of claim 3 wherein the proximity sensor comprises a capacitive circuit for generating an electrostatic field in the vicinity of the sensing area for detecting the first and second positions of the paddle.

6. The stall indicator of claim 3 wherein the proximity sensor comprises a solid-state switch for generating the first and second signals when the paddle is in the first and second positions, respectively.

7. The stall indicator of claim 6 wherein the solid-state switch generates the first and second signals through conduction and non-conduction states.

8. The stall indicator of claim 3 wherein the paddle comprises electrically conductive material.

9. The stall indicator of claim 2 wherein one end of the paddle is pivotably hinged to a surface of the housing and another end is disposed to extend beyond said wing a predetermined distance, said paddle movable with respect to said housing surface in response to air flow at said wing; and wherein the paddle is in the first position when close to the surface of the housing and is in the second position when away from the surface of the housing.

10. The stall indicator of claim 9 wherein the paddle is in the first position when at rest.

11. The stall indicator of claim 9 wherein the sensing area is in the vicinity of the housing surface.

12. The stall indicator of claim 1 wherein the structure is configurable to fit a curved surface of the leading edge of the wing and adjustable at said wing surface to render movement of the paddle with movement of a stagnation point.

13. The stall indicator of claim 1 wherein the proximity sensor is disposed within the housing and the housing is sealed.

14. The stall indicator of claim 1 wherein the housing comprises electrically non-conductive material.

15. The stall indicator of claim 1 wherein the paddle is in a rest position with respective to the sensing area under normal air flow conditions and movable variably to new positions with respect to the sensing area as the air flow approaches a stall condition; and wherein the proximity sensor detects the new positions of the paddle by electrical energy at the sensing area to generate a variable signal in proportion to the movement of the paddle away from the rest position.

16. A method of indicating when an aircraft is approaching a stall condition, said method comprising the steps of:
permitting a paddle, disposed at a leading edge of a wing of the aircraft, movement with respect to a sensing area in response to air flow at said wing;
detecting movement of said paddle by proximity sensing with electrical energy in the vicinity of the sensing area; and
effecting an electrical signal representative of said detected movement of said paddle, which signal being indicative of an approaching stall condition at said wing.

17. The method of claim 16 wherein the step of detecting includes generating electrical energy in the form of an electromagnetic field in the vicinity of the sensing area for detecting the movement of the paddle.

18. The method of claim 16 wherein the step of detecting includes generating electrical energy in the form of an electrostatic field in the vicinity of the sensing area for detecting the movement of the paddle.

19. The method of claim 16 wherein the step of detecting includes the steps of: affecting a change in the electrical energy by the movement of the paddle; and detecting a position of the paddle based on the affected change in electrical energy.

20. The method of claim 19 wherein the change in electrical energy is affected by an electrically conductive paddle.

21. The method of claim 16 wherein the electrical signal is effected through one of a conduction state and non-conduction state of a solid-state switch.

22. The method of claim 16 wherein the step of permitting includes the step of positioning the paddle at the leading edge of the wing to cause movement thereof is response to a changing position of a stagnation point.
